(19) United States
(12) Patent Application Publication
(10) Pub. No.: US 2025/0058611 A1
(43) Pub. Date: Feb. 20, 2025

(54) VEHICLE INTERCHANGEABLE CARTRIDGE

(71) Applicant: Canoo Technologies Inc., Torrance, CA (US)

(72) Inventors: Patrick Michael LaPlante, Southlake, TX (US); Mohnish Kumar, Riverside, CA (US)

(21) Appl. No.: 18/806,278

(22) Filed: Aug. 15, 2024

Related U.S. Application Data
(60) Provisional application No. 63/519,806, filed on Aug. 15, 2023.
(60) Provisional application No. 63/520,039, filed on Aug. 16, 2023.
(60) Provisional application No. 63/611,650, filed on Dec. 18, 2023.

(51) Int. Cl. B60J 5/10; B60P 1/43

(52) U.S. Cl. CPC B60J 5/108; B60P 1/435

(57) ABSTRACT

A cartridge rear closure system for a delivery van allows ready exchange of rear door(s). The system includes a frame for a rear door structure, either fitting around a rear end opening of the delivery van cargo storage enclosure, above a rear bumper for the delivery van. The frame either includes or receives door(s) or a door insert of a first type, and either the frame or the door insert is interchangeable with another frame or door insert for another rear door structure including door(s) of a second type. The types of door(s) may include barn doors, a tambour (roller) door, and a split tailgate/liftgate. Latches securing the frame or door insert preferably include a quick-release mechanism. The roller door slides within roller rails and, when raised, either onto roller rail extensions or into a roller door casing.

This application claims priority to U.S. Provisional Patent Application No. 63/519,806 filed Aug. 15, 2023, U.S. Provisional Patent Application No. 63/520,039 filed Aug. 16, 2023, U.S. Provisional Patent Application No. 63/611,650 filed Dec. 18, 2023. The content of the above-identified patent documents is incorporated herein by the reference.

### TECHNICAL FIELD

This disclosure relates generally to delivery vehicles. More specifically, this disclosure relates to rear closure of delivery vehicles.

### BACKGROUND

Vehicles having enclosed or partially enclosed rear cargo storage, such as vans and pickups, generally require a movable closure structure. When located at the rear, the movable closure may take the form of a tailgate for pickups, or of a tambour (roller) door for delivery vans. Different forms of the movable closure structure have different benefits and drawbacks. Accordingly, it is desirable to allow flexibility in the type of closure system provided on a delivery vehicle.

### SUMMARY

This disclosure relates to a cartridge rear closure system for a delivery van that allows ready exchange of rear door(s). The system includes a frame for a rear door structure, either fitting around a rear end opening of the delivery van cargo storage enclosure, above a rear bumper for the delivery van. The frame either includes or receives door(s) or a door insert of a first type, and either the frame or the door insert is interchangeable with another frame or door insert for another rear door structure including door(s) of a second type. The types of door(s) may include barn doors, a tambour (roller) door, and a split tailgate/liftgate. Latches securing the frame or door insert preferably include a quick-release mechanism. The roller door slides within roller rails and, when raised, either onto roller rail extensions or into a roller door casing.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example vehicle having a cartridge rear closure system according to embodiments of the present disclosure;

FIG. 2 illustrates an alternative example of a vehicle having a cartridge rear closure system according to embodiments of the present disclosure;

FIGS. 3A through 3F illustrate another alternative of a vehicle having a cartridge rear closure system according to embodiments of the present disclosure, utilizing a roller door on extended roller rails;

FIGS. 4A through 4R illustrate yet another alternative of a vehicle having a cartridge rear closure system according to embodiments of the present disclosure, utilizing a roller door; and

FIG. 5 illustrates a folding ramp for use with a vehicle having a cartridge rear closure system according to embodiments of the present disclosure.

### DETAILED DESCRIPTION

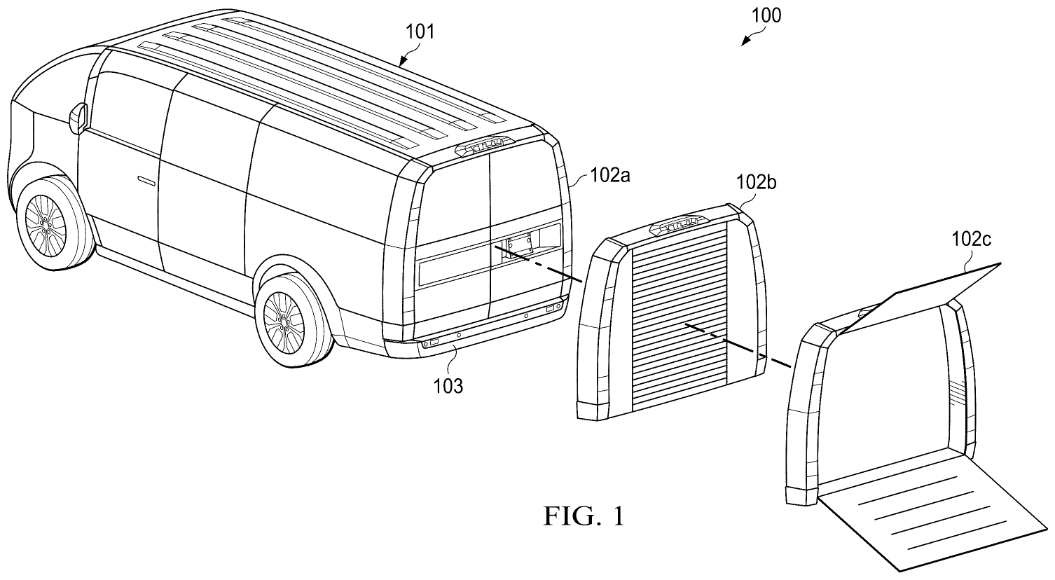

FIGS. 1 through 5, described below, and the various embodiments used to describe the principles of this disclosure are by way of illustration only and should not be construed in any way to limit the scope of this disclosure. Those skilled in the art will understand that the principles of this disclosure may be implemented in any type of suitably arranged device or system.

For delivery vans with an enclosed rear cargo storage area and a rear door, different closure structures offer different benefits and disadvantages. When open, barn door style rear doors can allow the largest opening for loading and unloading cargo. However, such doors cannot be opened or closed while the van is backed up close to a loading dock. Rolling segmented doors or sliding slat doors (i.e., tambour doors) can be opened and closed while the van abuts a loading dock, but requires space around the rear opening to support the ends of the door segments or slats. Split tailgate doors, with a portion that drops outward and downward and a portion that lifts outward and upward, can provide a ramp for wheeling cargo into and out of the cargo area, but be problematic for loading non-rolling cargo from the typical height of a loading dock.

For general purpose delivery between a variety of different types of pick-up and delivery points, it would be desirable to use different rear closure structures for different types of locations, such as elevated loading docks versus ground level loading and unloading areas. However, having special purpose delivery vehicles with different types of rear closures may be cost prohibitive. The present disclosure provides a cartridge rear door system in which the rear closure structure may be readily exchanged.

FIG. 1 illustrates an example vehicle having a cartridge rear closure system according to embodiments of the present disclosure. The embodiment of the electric vehicle 100 illustrated in FIG. 1 is for illustration and explanation only. FIG. 1 does not limit the scope of this disclosure to any particular implementation of electric vehicle.

In the example illustrated in FIG. 1, the vehicle 100 is a delivery vehicle, preferably an electric vehicle, with enclosed rear storage 101—that is, a van. Vehicle 100 may include a top hat structure coupled to a vehicle platform, where the platform of vehicle 100 includes a chassis (not visible in FIG. 1) supports a body 101 for carrying the operator, passengers and/or cargo. In some embodiments, the chassis of the vehicle 100 is in the form of a “skateboard” vehicle platform supporting the one or more energy storage elements (batteries) that provide input electrical power used by various components, such as one or more electric motors of the vehicle 100 and a control system of the electric vehicle 100, as described in any of U.S. Pat. No. 11,161,402B2, U.S. Pat. No. 11,292,326B2, U.S. Patent Application Publication No. 2021/0122223A1, U.S. Patent Application Publication No. 2020/0369140A1, and/or U.S. Patent Application Publication No. 2023/0102921A1, the content of each of which is incorporated herein by reference. The top hat structure is designed and dimensioned to have at least a cabin configured to provide space for one or more persons to sit and either operate or ride in the electric vehicle. The vehicle may be manufactured as described in U.S. Patent Application Publication No. 2022/0055701A1, the content of which is incorporated herein by reference.

The enclosure for the rear cargo area 101 of vehicle 100 has an end configured to receive one of a plurality of rear door structures 102a, 102b, or 102c. Each rear door structures 102a, 102b, and 102c includes a frame fitting over and around the end of the cargo area. The end of the cargo area may have projecting tabs or an indented outer surface (not shown) for the purpose of receiving a counterpart structure on the frame. A number of latches (not shown) secure the rear door structure 102a, 102b, or 102c to the end of the cargo area in a manner allowing quick release, removal, and exchange of one rear door structure for another. The latches are inside the frame, and inside the rear door(s) mounted on the frame when the frame is secured to the end of the cargo area, to prevent removal of the rear door(s) when those door(s) are locked. As shown in the figure, the frame is above, and may rest upon, the rear bumper 103 for the vehicle 100, which is permanently mounted to the chassis for the vehicle 100.

This interchangeable rear cargo cartridge offers customers the ability to change between a barn door rear door structure 102a, a tambour rear door structure 102b, and a split tailgate/liftgate rear door structure 102c. The dual 50/50 barn doors in rear door structure 102a preferably mount the doors with 270-degree hinges so that the doors fold backwards against the body when fully opened, providing ease of cargo access and easier loading of large objects. The sliding slats of the tambour rear door structure 102b roll up inside an upper region of the doorway as the door is opened upwards. The tailgate portion of the split tailgate/liftgate rear door structure 102c forms a loading ramp when lowered so that one edge rests on the ground.

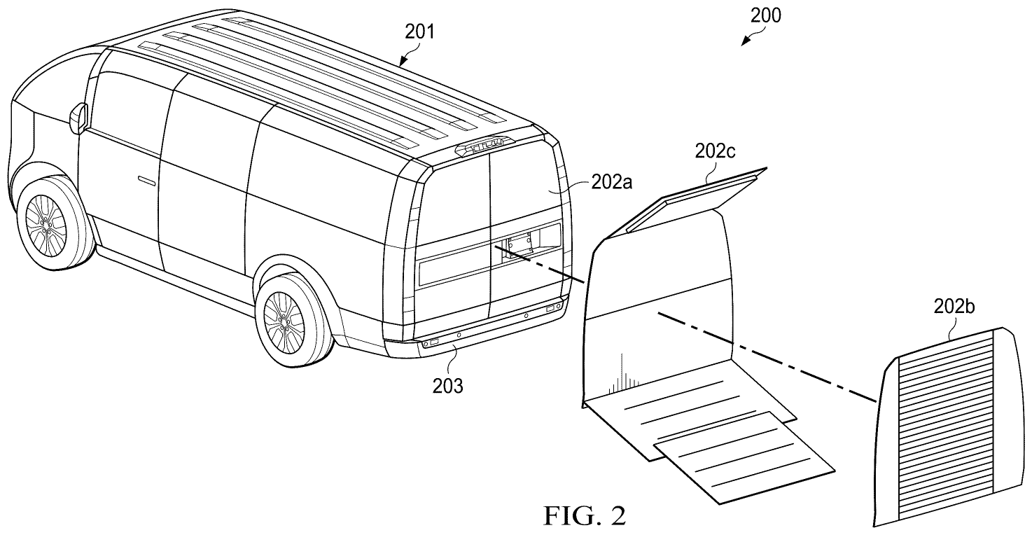

FIG. 2 illustrates an alternative example of a vehicle having a cartridge rear closure system according to embodiments of the present disclosure. The embodiment of the electric vehicle 200 illustrated in FIG. 2 is for illustration and explanation only. FIG. 2 does not limit the scope of this disclosure to any particular implementation of electric vehicle.

In the example illustrated in FIG. 2, the vehicle 200 is a delivery vehicle with enclosed rear storage 201 having an overall general construction similar to that of vehicle 100. The enclosure for the rear cargo area 201 of vehicle 200 has an end configured to receive one of a plurality of rear door inserts 202a, 202b, or 202c. In contrast with the embodiment of FIG. 1, the frame is integrally formed at the end of the cargo area and is configured to receive one of the rear door inserts 202a, 202b, or 202c, which may be latched or otherwise quickly secured within the frame. As with the embodiment of FIG. 1, the frame is above the rear bumper 203 for the vehicle 200, which is permanently mounted to the chassis for the vehicle 200. The interchangeable rear door inserts offer customers a comparable ability to change between a barn door rear door structure 202a, a tambour rear door structure 202b, and a split tailgate/liftgate rear door structure 202c. While rear door inserts 202a, 202b, or 202c are similar to the counterpart structures in rear door structures 102a, 102b, and 102c, FIG. 2 explicitly illustrates that the tailgate portion of the split tailgate/liftgate rear door structure 202c may include a sliding extension as part of forming a ramp. The same feature may be provided with the split tailgate/liftgate rear door structure 102c.

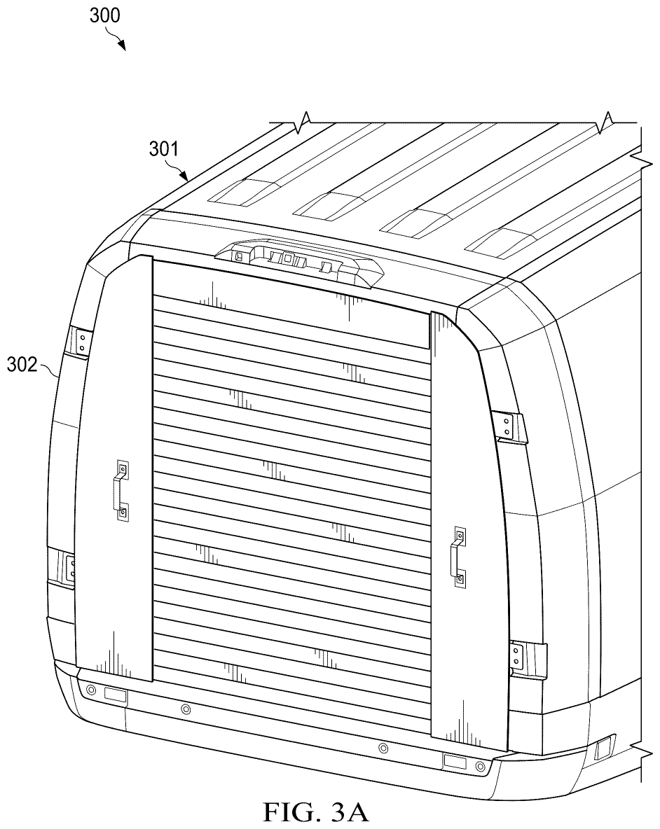

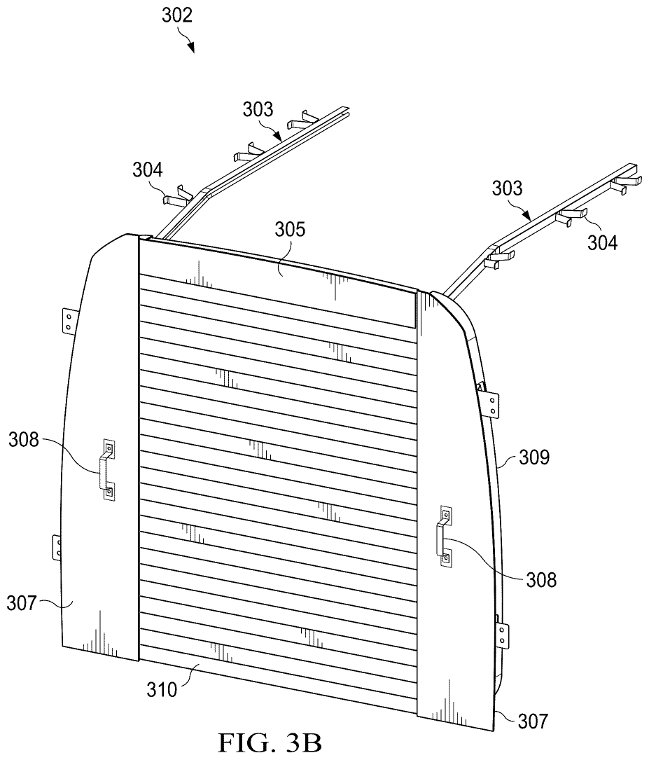

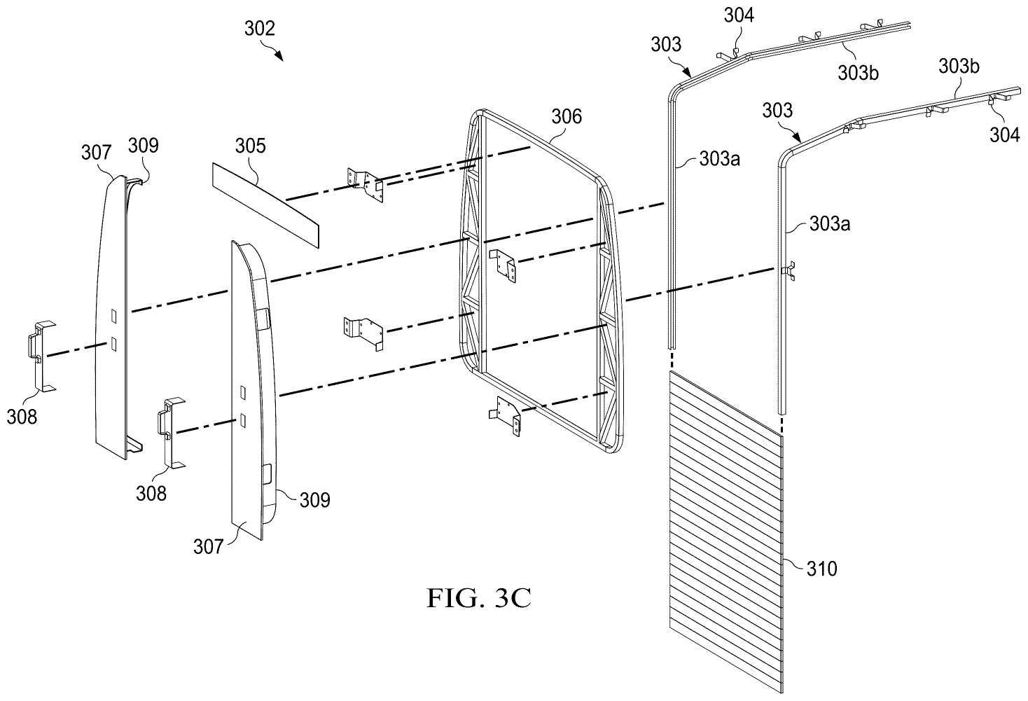

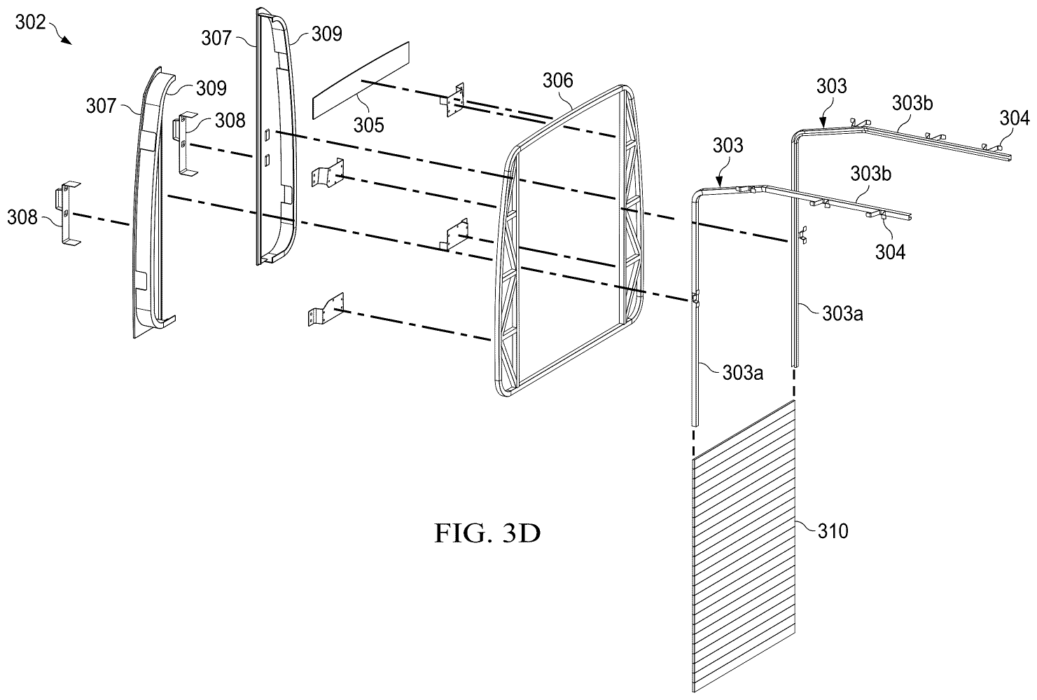

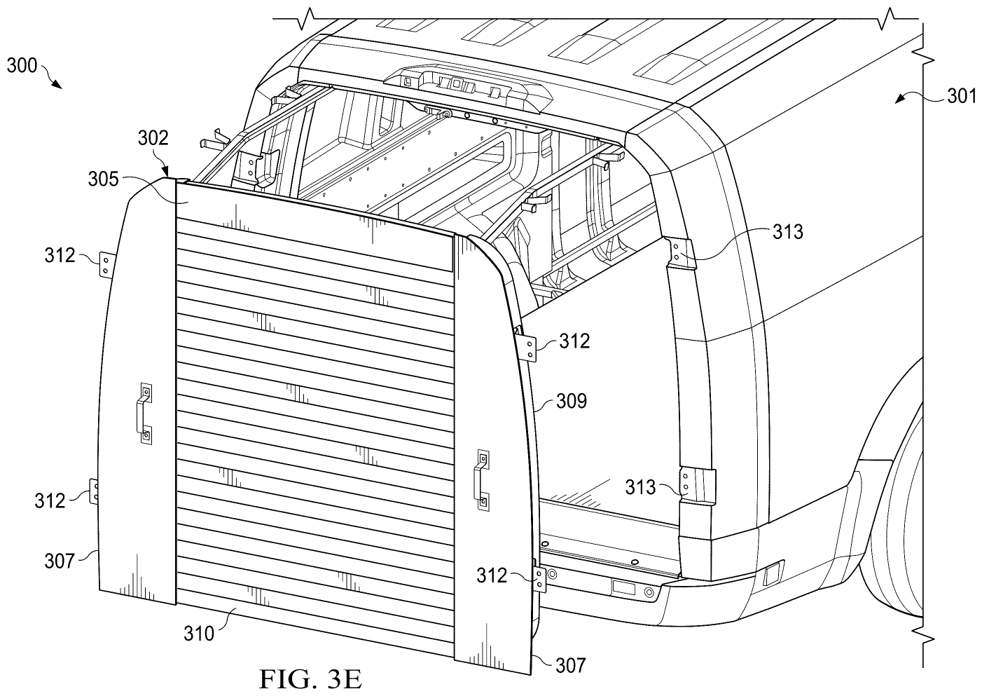

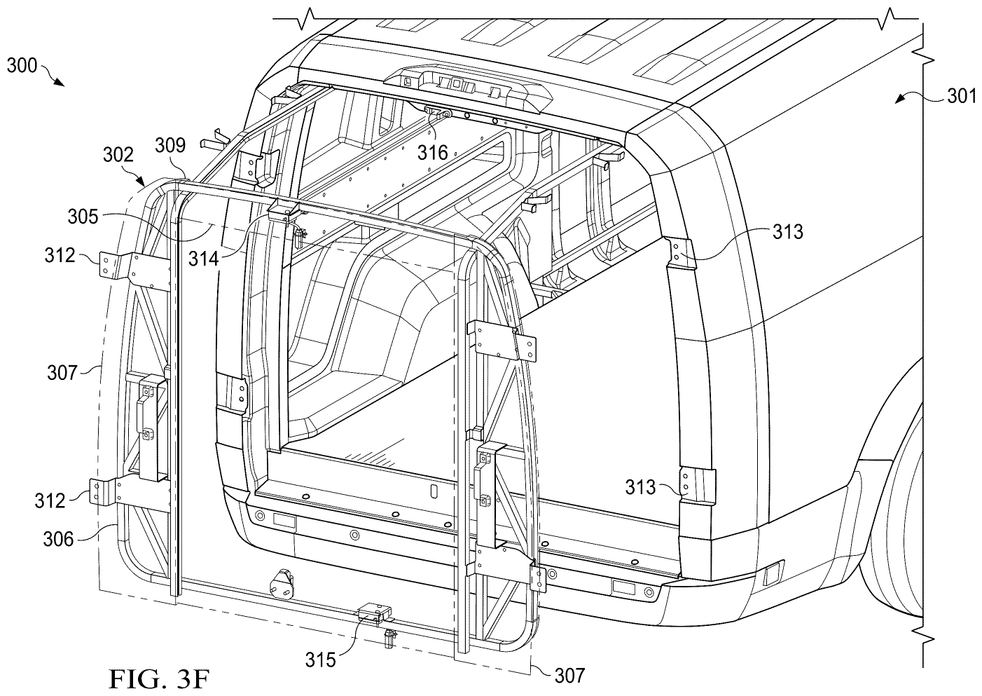

FIGS. 3A through 3F illustrate a portion of another alternative of a vehicle having a cartridge rear closure system according to embodiments of the present disclosure. The embodiments of the electric vehicle 300 illustrated in FIGS. 3A through 3E are for illustration and explanation only. FIGS. 3A through 3F do not limit the scope of this disclosure to any particular implementation of electric vehicle.

In the example illustrated by FIGS. 3A through 3F, the vehicle 300 is a delivery vehicle with rear cargo storage area 301, and having an overall general construction similar to that of vehicles 100 and 200. The enclosure for the rear cargo storage area 301 of vehicle 300 has an end configured to receive one of a plurality of rear door inserts. In the example depicted, the rear door insert 302 is a roller (tambour) door mounted on extended roller rails.

FIG. 3A illustrates the vehicle 300 with the rear door insert 302 mounted thereon and the roller door closed. FIG. 3B depicts an assembled view, and FIGS. 3C and 3D are different exploded views, of a roller door insert 302 utilizing an extended rail system. Roller door insert 302 includes roller rails 303 each with a set of body mounting brackets 304. Roller rails 303 include roller rail verticals 303a and roller rail extensions 303b. A rear, vertical portion of roller rails 303a supports an upper fixed panel 305 and a frame 306. Frame 306, in turn, supports exterior panels 307 with handles 308 and exterior side fixed panels 309. Exterior side fixed panels 309 are mounted on either side of frame 306 and upper fixed panel 305 is mounted therebetween. Roller door 310 is formed of connected slats retained within and sliding along roller rails 303a, 303b.

FIGS. 3E and 3F each illustrate mounting of the roller door insert 302 in the end of the vehicle 300, to enclose rear cargo storage area 301. The pre-assembled roller door insert 302 shown FIG. 3B is inserted into the end of vehicle 300 and secured in place as illustrated by FIGS. 3E and 3F. (In FIG. 3F, portions of roller door insert 302 are depicted as transparent or semi-transparent in order to better illustrate other features.) Hinges 312 on exterior panels 307 of rear door insert 302 correspond to with hinge insets 313 on the body of vehicle 300, and facilitate alignment of the rear door insert 302 with the body of the vehicle 300. Those hinges 312 allow the exterior panels 307 to be opened for access to storage space defined by the frame 306 and exterior side fixed panels 309. Alignment is also facilitated by upper and lower latches 314, 315 mounted to the frame 306 of the rear door insert 302 that correspond to upper and lower striker plates 316 (lower striker place not visible) that remain on the vehicle 300 when rear door insert 302 is removed. To further secure the rear door insert 302 in place, body mounting brackets 304 on roller rails 303 are bolted to the body of the vehicle 300.

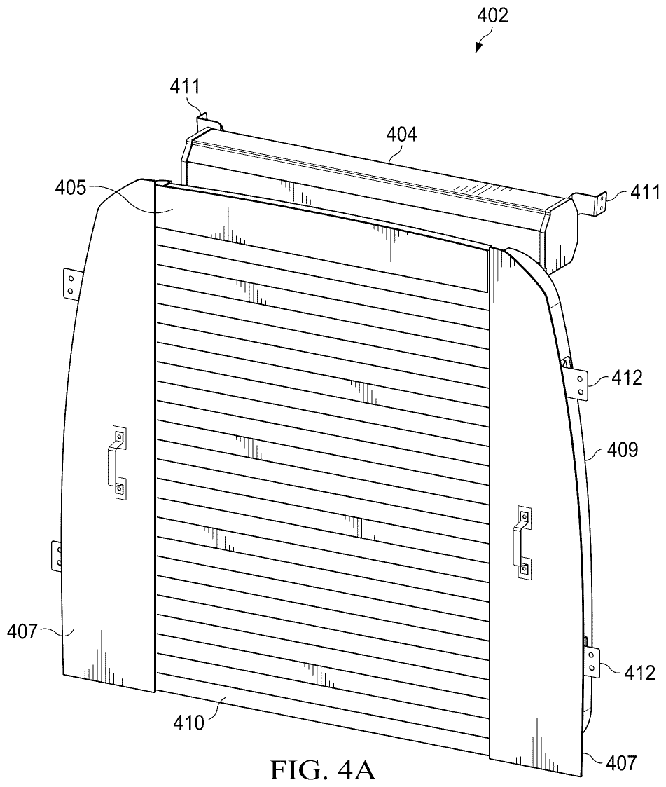

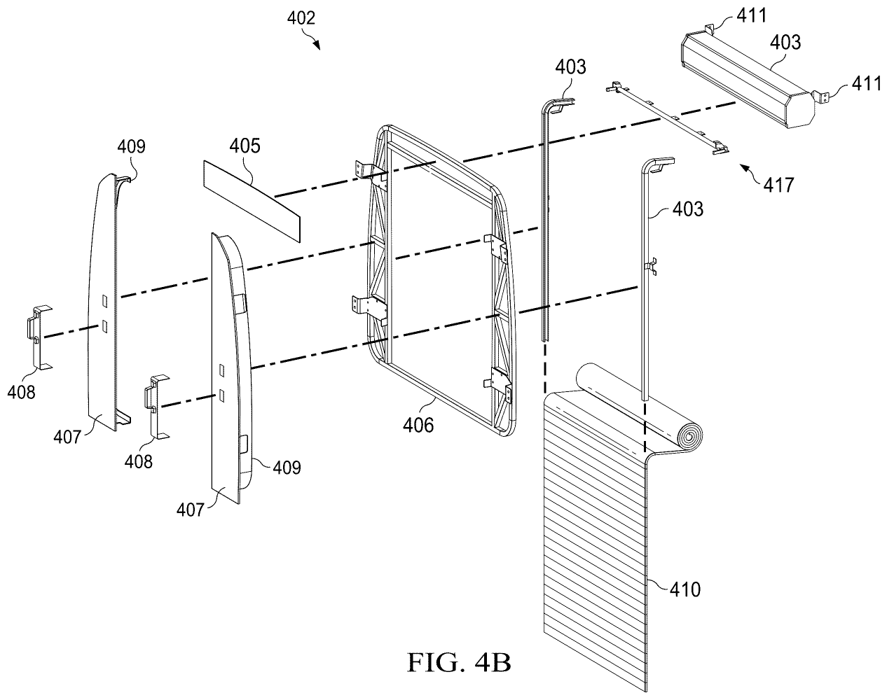

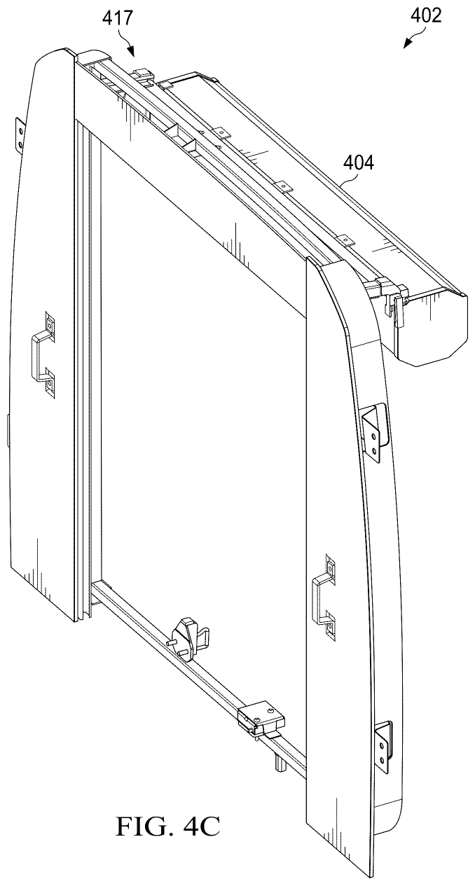

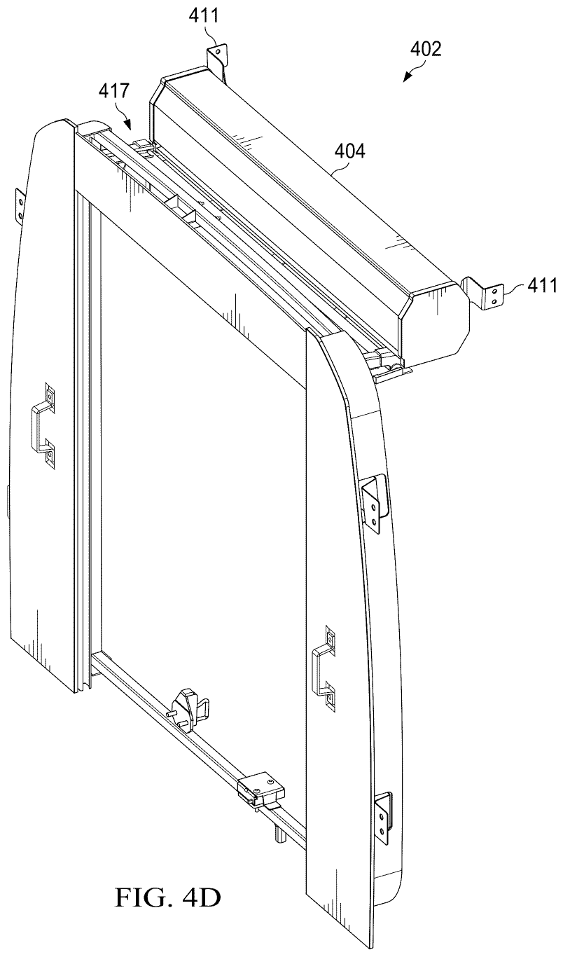

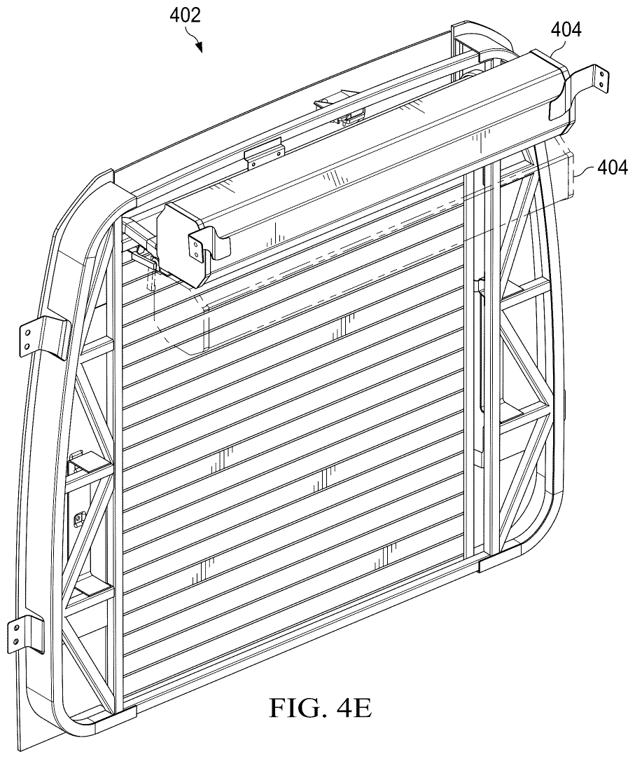

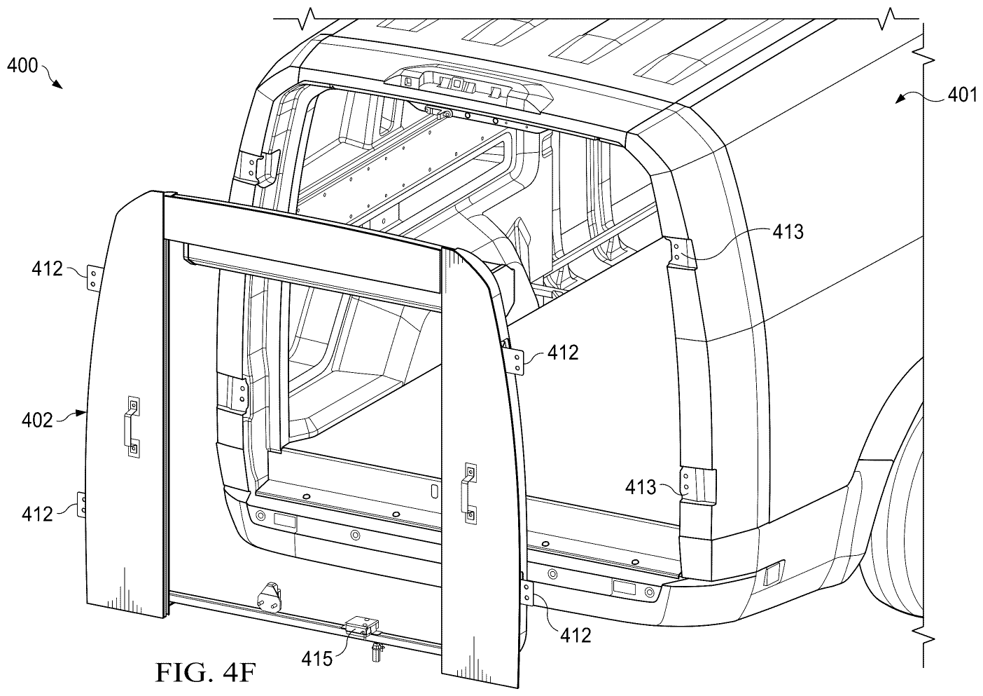

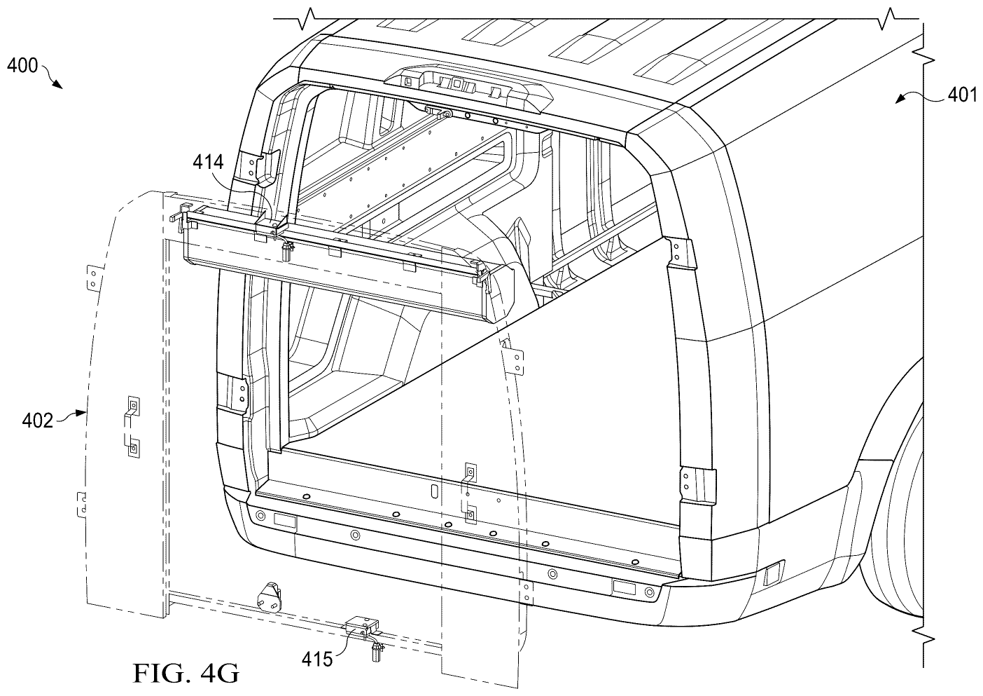

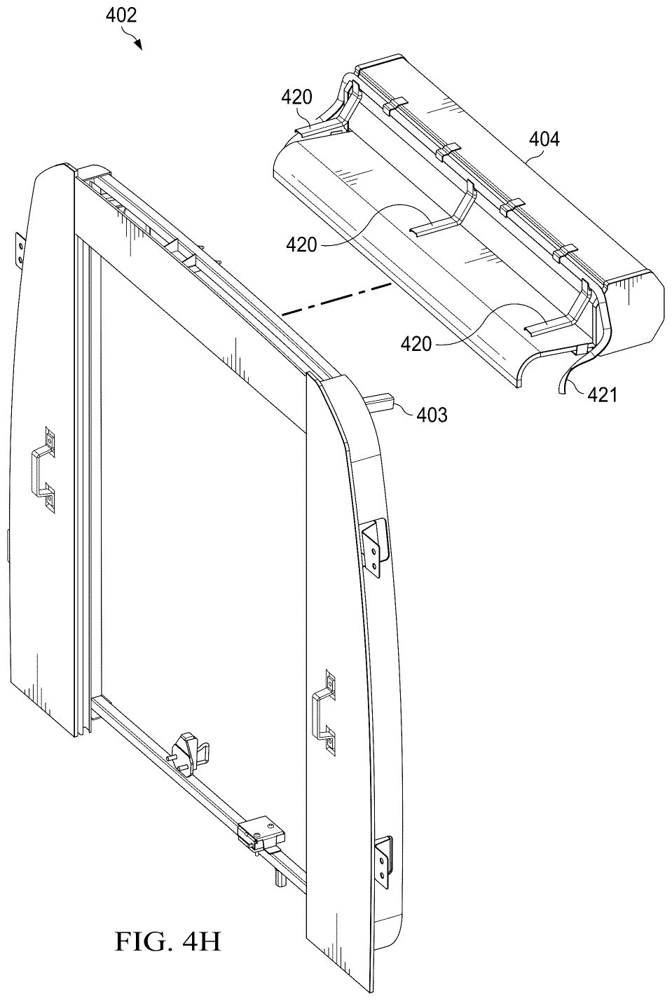

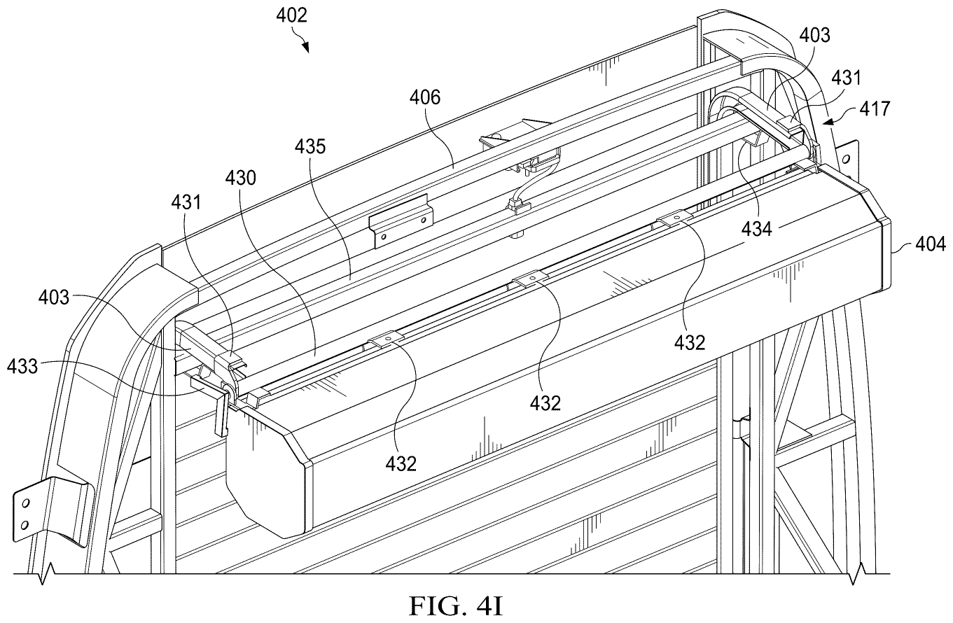

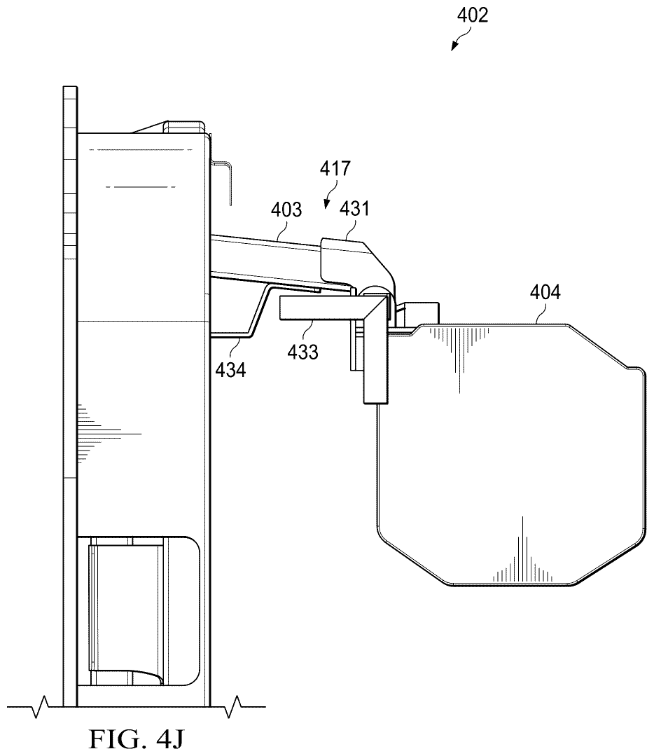

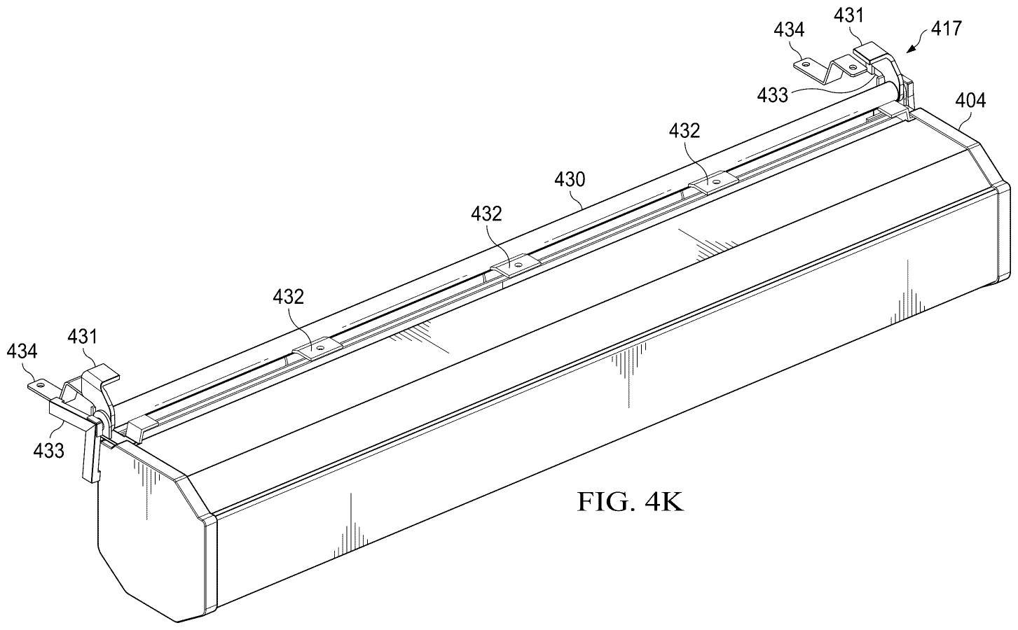

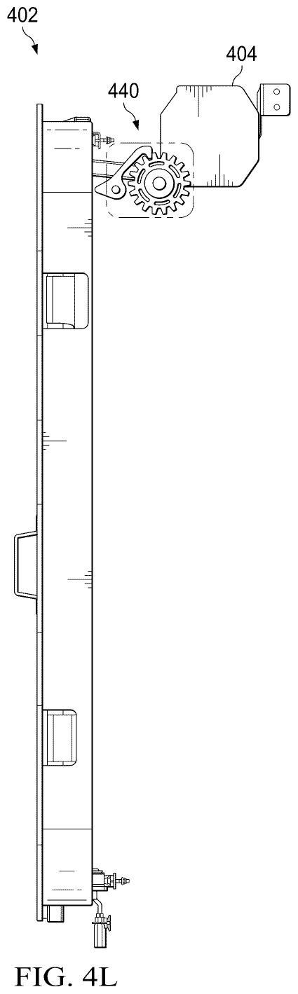

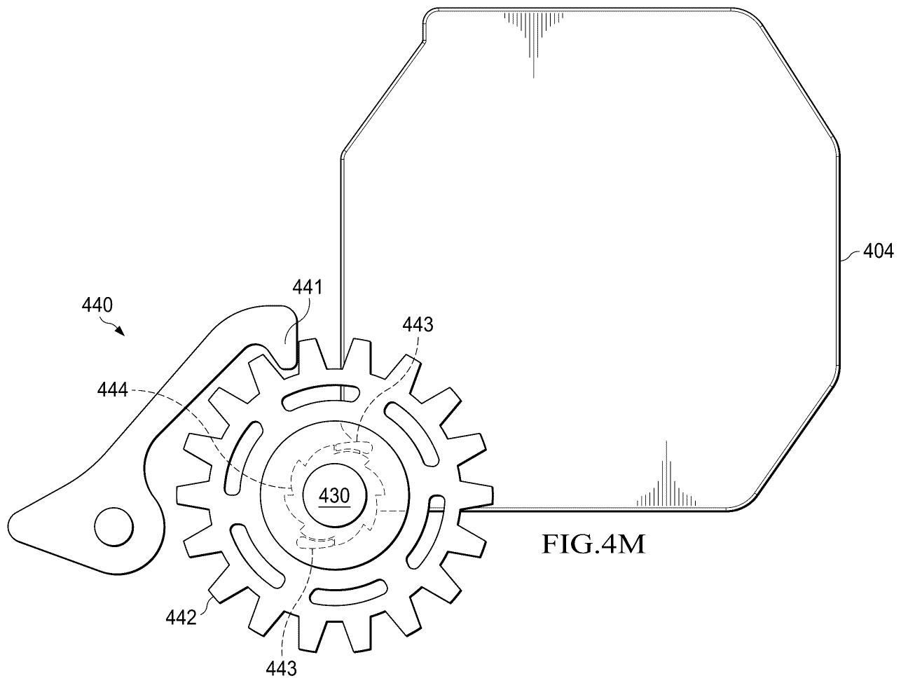

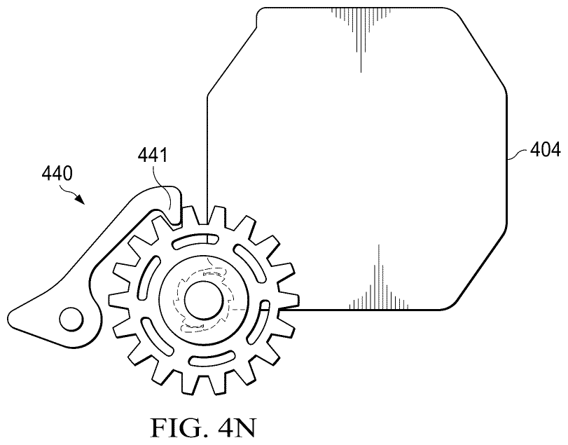

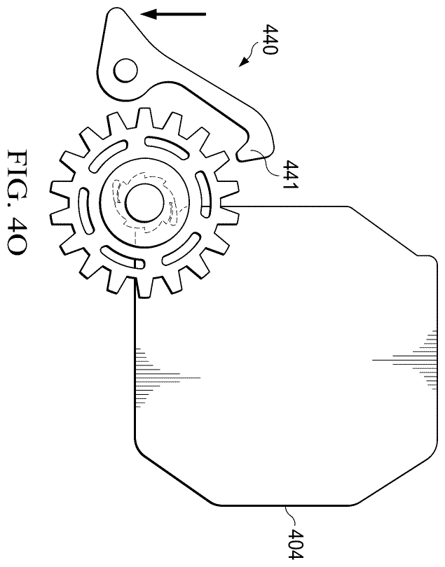

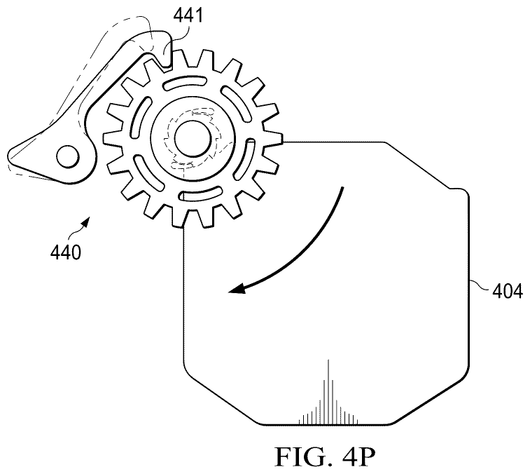

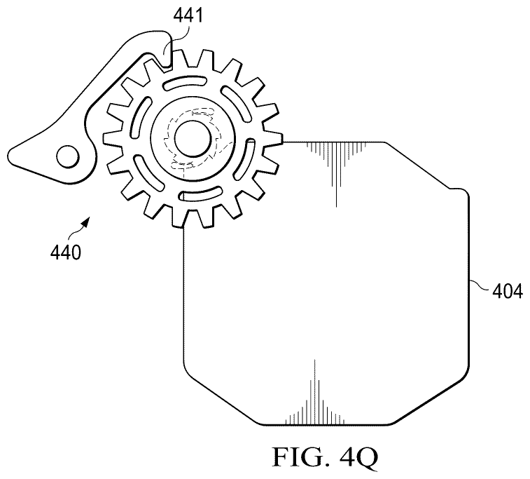

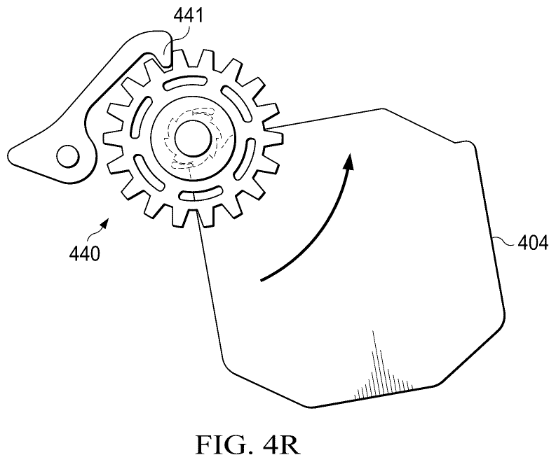

FIGS. 4A through 4R illustrate a portion of yet another alternative of a vehicle having a cartridge rear closure system according to embodiments of the present disclosure. The embodiments of the electric vehicle 400 illustrated in FIGS. 4A through 4R are for illustration and explanation only. FIGS. 4A through 4R do not limit the scope of this disclosure to any particular implementation of electric vehicle.

In the example illustrated by FIGS. 4A through 4R, the vehicle 400 is a delivery vehicle with rear cargo storage area 401, and having an overall general construction similar to that of vehicles 100, 200, and 300. The enclosure for the rear cargo storage area of vehicle has an end configured to receive one of a plurality of rear door inserts. In the example depicted, the rear door insert 402 is a roller (tambour) door.

FIG. 4A illustrates an assembled view and FIG. 4B is an exploded view of a roller door insert 402 utilizing roller rails and a roller door casing. Roller door insert 402 includes roller rails 403 having upper ends feeding into a roller door casing 404. Roller rails 403 support an upper fixed panel 405 and/or a frame 406, and a rear portion of roller door casing 404 is mounted, via pivot assembly 417, to the upper fixed panel 405 and/or the frame 406. Roller door casing 404 also includes brackets 411 for securing the roller door casing 404 to the interior of the vehicle when the roller door insert 402 is installed. Frame 406 also supports exterior panels 407 with handles 408 and exterior side fixed panels 409. Exterior side fixed panels 409 are mounted on either side of frame 406 and upper fixed panel 405 is mounted therebetween. Roller door 410 is formed of a segment of connected slats and a continuous segment, both retained within and sliding along roller rails 403 and into or out of roller door casing 404.

FIGS. 4C, 4D, and 4E illustrate rotation of roller door casing 404 for insertion or removal of roller door insert 402 at the end of a vehicle (FIG. 4C) or versus use of the vehicle on which roller door insert 402 is secured (FIG. 4D). Roller door casing 404 rotates about pivot assembly 417 between a lowered position depicted in FIG. 4C, for installation or removal of roller door insert 402 on a vehicle, and a raised position depicted in FIG. 4D, for operation of the vehicle on which rear door insert 402 is mounted. FIG. 4E shows roller door casing 404 in both the raised position and the lowered position (in phantom).

FIGS. 4F and 4G each illustrate mounting of the roller door insert 402 in the end of the vehicle 400, to enclose rear cargo storage area 401. The pre-assembled roller door insert 402 shown FIG. 4A is inserted into the end of vehicle 400 and secured in place as illustrated by FIGS. 4F and 4G. (In FIG. 4G, portions of roller door insert 402 are depicted as semi-transparent in order to illustrate other features.) Hinges 412 on exterior panels 407 of rear door insert 402 correspond to with hinge insets 413 on the body of vehicle 400, and facilitate alignment of the rear door insert 402 with the body of the vehicle 400. Those hinges 412 allow the exterior panels 407 to be opened for access to storage space defined by the frame 406 and exterior side fixed panels 409. Alignment is also facilitated by upper and lower latches 414, 415 mounted to the frame 406 of the rear door insert 402 that correspond to upper and lower striker plates that remain on the vehicle 400 when rear door insert 402 is removed. To further secure the rear door insert 402 in place, body mounting brackets on roller rails 403 and brackets 411 on roller door casing 404 are bolted to the body of the vehicle 400.

FIG. 4H illustrates an embodiment of roller door insert 402 employing an independent frame structure, for use with the roller door casing 404 or with extended roller rails as described above for the embodiments of FIGS. 3A through 3F. In this embodiment, the roller door casing 404 includes frame mounting brackets 420 for securing the roller door casing 404 to the frame structure (which includes flanges not visible in FIG. 4H). Roller rails 403 connect to guides 421 on the roller door casing 404. The roller door casing 404 can be secured to the inside of the vehicle by brackets as described above. In this embodiment, the pivot assembly 417 may not be necessary, since the roller door casing 404 can be installed after the remainder of the roller door insert 402 is mounted on the vehicle. Also in this embodiment, the remainder of the roller door insert 402 (other than the roller door casing 404) can be fitted with roller rail extensions and used in the manner of the embodiments of FIGS. 3A through 3F.

FIGS. 4I, 4J, and 4K illustrate additional details of the pivot assembly 417 for roller door casing 404. Pivot assembly 417 includes a pivot shaft 430 between pivot mounting brackets 431, which each include a portion receiving the end of roller rails 430 and portion secured to the housing for roller door casing 404. Also attached to pivot shaft 430 are casing support brackets 432, for securing the pivot assembly 417 and roller door casing 404 to the vehicle. Release levers 433 on both ends of pivot shaft 403 selectively lock the roller door casing 404 in position or permit rotation of roller door casing 404 around pivot shaft 430. Although not directly affixed to the remainder of pivot assembly 417, pivot assembly 417 also include additional brackets 434 supporting the ends of the roller rails 403, attached to a crossmember 435 of the frame 406 for roller door insert 402.

FIGS. 4L through 4R illustrate an optional rachet mechanism for roller door casing 404. The rachet mechanism 440 is affixed to at least one end of the pivot shaft (not visible in FIGS. 4L through 4R), and controls raising and lowering of the roller door casing 404. FIG. 4L depicts the location of the rachet mechanism 440 relative to the roller door casing 404 and the remainder of roller door insert 402, while FIG. 4M illustrates components of one embodiment of the rachet mechanism 440. A release lever includes a block 441 preventing rotation of the external gear wheel 442. Spring-loaded stoppers 443 prevent rotation of a rachet wheel 444 affixed to an end of the pivot shaft 430 in a clockwise direction, while allowing free rotation in an anti-clockwise direction. Therefore, to shift the roller door casing 404 from the raised position to the lowered position, the block 441 must be moved from between teeth on the external gear wheel 442 as depicted in FIGS. 4N, 40 and 4P. By contrast, to shift the roller door casing 404 from the lowered position to the raised position, the block 441 need not be moved, as illustrated by FIGS. 4Q and 4R.

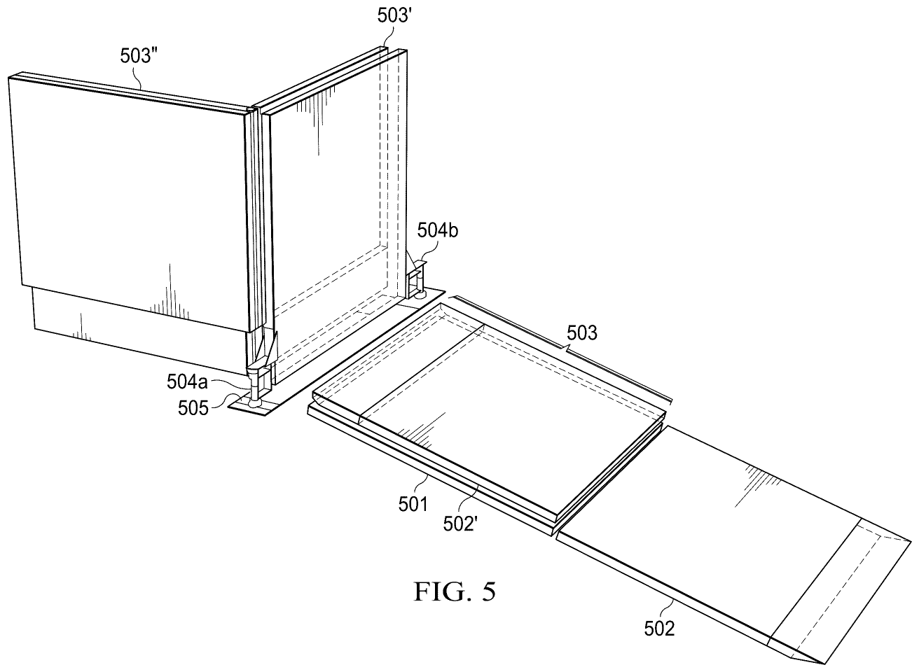

FIG. 5 illustrates a folding ramp for use with a vehicle having a cartridge rear closure system according to embodiments of the present disclosure. The embodiment shown in FIG. 5 is for illustration and explanation only. FIG. 5 does not limit the scope of this disclosure to any particular implementation of a folding ramp.

In conjunction with a cartridge rear closure system for delivery vehicles, a ramp is desirable for wheeling cargo into or out of the cargo storage on a dolly or hand truck. In the exemplary embodiment of FIG. 5, the ramp folds down for use, and folds up and rotates in for storage. The ramp 500 includes an upper panel 501 and a lower panel 502. The lower panel 502 is shown in both an extended position and a folded position 502′. When the lower panel 502 is in the folded position 502′, the combined upper and lower panels 503 may be rotated from the lowered position shown to a first upright position 503′. A portion of the upper panel 501 is rotatably secured to uprights 504a, 504b extending from a base 505 for a mounting frame secured to the bottom of the rear or side opening for the delivery van. (In FIG. 5, the ramp is shown as separated from the uprights 504a, 504b when in the lowered position, solely for the purposes of illustration clarity). The upper panel 501 is pivotably connected near the rearmost edge to uprights for the mounting frame 504, to permit movement from the lowered position shown to the first upright position 503′. The combined upper and lower panels 503 may also be rotated from the first upright position 503′ to a second upright position 503″, into the cargo storage area of the delivery vehicle and aligned with one vehicle sidewall, so that the ramp does not block the rear or side opening of the delivery vehicle. The connection between the upper panel 501 and one upright 504b for the mounting frame may be released, and the connection between the upper panel 501 and the other upright 504a for the mounting frame is pivotable about two axes. Those features allow rotation of the combined panels 503 from the first upright position 503′ to the second upright position 503″.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A rear door system for a delivery van, the rear door system comprising:
a frame for a rear door structure that is one of integrally formed with or configured to fit around an opening at a rear end of a cargo storage enclosure, wherein one of the frame or a rear door insert for the frame is interchangeable with another frame for another rear door structure or another rear door insert; and
latches for securing one of the frame to the rear end of the cargo storage enclosure or the rear door insert to the frame.

2. The delivery van rear door system according to claim 1, wherein one of the rear door structure or the rear door insert includes one of barn doors, a tambour door, a split tailgate/liftgate, or a roller door.

3. The delivery van rear door system according to claim 1, wherein the latches are inside the frame and inside the rear door(s) mounted in the frame.

4. The delivery van rear door system according to claim 1, further comprising:
a bumper mounted to a chassis for the delivery van, the frame positioned above the bumper.

5. The delivery van rear door system according to claim 1, wherein, when the one of the rear door structure or the rear door insert include a split tailgate/liftgate, a tailgate portion of the split tailgate/liftgate rear door structure forms a loading ramp when lowered.

6. The delivery van rear door system according to claim 1, wherein, when the frame for the rear door structure is configured to fit around the opening at the rear end of the cargo storage enclosure, an end of the cargo storage enclosure includes indented surfaces sized and positioned to receive projecting tabs on the frame.

7. A delivery van including the delivery van rear door system according to claim 1, the delivery van further comprising:
a body including the cargo storage enclosure; and
wheels mounted to support the body.

8. A delivery van rear door system for a delivery van, the rear door system comprising:
an opening at a rear end of a cargo storage enclosure;
a rear door insert configured to fit over the opening; and
a roller door mounted on roller rails on the rear door insert, the roller door configured to slide along the roller rails,
wherein the roller door closes a door opening in the roller door insert when the roller door is slid down on the roller rails, and
wherein the roller door exposes the door opening when the roller door is slid up on the roller rails.

9. The delivery van rear door system according to claim 8, wherein the roller rails include roller rail verticals holding the roller door when the roller door in a closed position and roller rail extensions holding at least a portion of the roller door when the roller door is in an open position.

10. The delivery van rear door system according to claim 9, wherein the roller rail extensions extend along an upper surface of the cargo storage enclosure.

11. The delivery van rear door system according to claim 8, wherein the roller rails have upper ends feeding into a roller door casing, and wherein the roller door is would around a pivot member within the roller door casing when the roller door is in an open position.

12. The delivery van rear door system according to claim 11, wherein the roller door casing rotates between a lowered position for installation or removal of the rear door insert and a raised position for operation of the delivery van.

13. The delivery van rear door system according to claim 12, further comprising:
at least one release lever for locking the roller door casing in one of the lowered position and the raised position.

14. The delivery van rear door system according to claim 12, further comprising:
a rachet mechanism mounted to the pivot member for retaining the roller door wound within the roller door casing.

15. The delivery van rear door system according to claim 8, wherein the roller door comprises a plurality of connected slats and a continuous segment.

16. A delivery van including the delivery van rear door system according to claim 8, the delivery van further comprising:
a body including the cargo storage enclosure; and
wheels mounted to support the body.

17. A folding ramp for use with a delivery van, the folding ramp comprising:
an upper ramp panel and a lower ramp panel connected to fold adjacent to each other or to extend to form a continuous surface; and
a mounting frame configured to be secured to a bottom of an opening of the delivery van, the mounting frame including a first upright and a second upright;
wherein an edge of the upper ramp panel is pivotably connected to the first and second uprights to permit rotation of the upper and lower ramp panels from a lowered position to a first raised position, and
wherein a connection of the edge of the upper ramp panel to one of the first and second uprights is releasable, to permit rotation of the upper and lower ramp panels from the first raised position to a second raised position.

18. The folding ramp according to claim 16, wherein the first raised position is within the opening of the delivery van and the second raised position is within a cargo space for the delivery van.
